(19) United States
(12) Patent Application Publication
(10) Pub. No.: US 2026/0119863 A1
(43) Pub. Date: Apr. 30, 2026

(54) UNCERTAINTY ESTIMATION FOR DEEP LEARNING (DL)-BASED OBJECT TRACKING SYSTEMS

(71) Applicant: QUALCOMM Incorporated, San Diego, CA (US)

(72) Inventors: Sai Madhuraj JADHAV, Foster City, CA (US); Amin ANSARI, Kirkland, WA (US); Madhumitha SAKTHI, Dublin, CA (US); Avdhut JOSHI, San Marcos, CA (US); Thomas SVANTESSON, Linköping (SE)

(21) Appl. No.: 18/932,419

(22) Filed: Oct. 30, 2024

(51) Int. Cl. G06N 3/08

(52) U.S. Cl. CPC G06N 3/08

(57) ABSTRACT

Certain aspects of the present disclosure provide techniques for uncertainty estimation, such as for deep learning (DL)-based object tracking systems. A method generally includes processing, with a deep learning network, an input state associated with an object to predict an output state for the object, wherein the output state comprises a plurality of state estimates for a first time period; and generating a state covariance based at least in part on estimated covariance between at least two state estimates of the plurality of state estimates, wherein the state covariance represents an estimated uncertainty associated with the output state.

### INTRODUCTION

### Field of the Disclosure

Aspects of the present disclosure relate to techniques for uncertainty estimation, such as for deep learning (DL)-based object tracking systems.

### DESCRIPTION OF RELATED ART

Object tracking is an important computer vision task that aims to estimate the object state(s) (e.g., (e.g., velocity, size, orientation, heading, semantic class, etc.) and/or trajectory(ies) of one or more objects of interest (e.g., cars, pedestrians, bicycles, etc.) across successive frames. For example, multiple object tracking (MOT) may include predicting object states and trajectories for multiple target objects across a video sequence of frames. The objective of object tracking is to maintain a consistent association and track identifier (ID) between an object and its representation across different frames, despite changes in position, scale, orientation, and/or appearance, including when the object temporarily disappears from view and/or becomes obscured. Object tracking may include two-dimensional (2D) and three-dimensional (3D) object tracking. While 2D object tracking operates to track object(s) based on individual image frames, 3D object tracking is based on identifying and monitoring object(s) in a 3D environment based on spatial and temporal information present in 3D data representations (e.g., such as point cloud sequences).

Object tracking, including 2D and/or 3D object tracking, is one of the core tasks in computer vision, which may be used to facilitate scene understanding. Object tracking is fundamental in various applications, including autonomous driving, robot navigation, augmented reality, security and surveillance, sports analysis, and/or crowd monitoring, to name a few. For example, an autonomous vehicle may use object tracking to predict the motion of objects, such as pedestrians, vehicles, and/or cyclists, in its surrounding. This helps the vehicle to navigate safely and efficiently. As another example, object tracking may be a key component of surveillance systems, which helps to identify suspicious activities, track individuals and objects of interest, and/or detect anomalies.

One approach to 3D object tracking includes using a tracking-by-detection (TBD) method in combination with a tracking filter (e.g., “single-frame recursive filtering” and/or a “sliding window approach”). The TBD method may include two steps: (1) a detection step and (2) an association step. During the detection step, one or more detections may be made within a given frame or observation window, where a “detection” refers to the identification and localization of an object or object state. This identification may be represented by various data types, such as bounding boxe(es), point(s), cluster(s), and/or the like (e.g., such as depending on sensor modality and the specific application for the object tracking). The association step may include assigning each detection to an existing trajectory (e.g., a “track,” which may refer to a temporal sequence of detections associated with a single object over multiple frames). Put differently, the TBD method handles data association by linking current detection(s) (e.g., associated with the given frame or observation window) with previously-created track(s).

An association between a current detection and a previously-created track may include updating a tracking filter associated with the track. Specifically, a tracking filter may be or may implement an algorithm used to predict object movements. For an existing track, newly-associated detections may be used by the tracking filter to update the state of an object associated with the existing track. The tracking filter may use this updated state to predict (e.g., estimate) a future state of the object (e.g., predicting the position and other relevant information about the object) for object tracking. Put differently, the tracking filter may use the updated state to improve its prediction about a future state of the object assuming the model holds true. Example tracking filters may include various types of Kalman filters, such as a linear Kalman filter, an extended Kalman filter (EKF), an unscented Kalman filter (UKF), and/or non-Gaussian filters, such as a Gaussian-sum filter or a particle filter (PF), although other tracking filters may be considered.

### SUMMARY

One aspect provides a method for uncertainty estimation. The method generally includes processing, with a deep learning network, an input state associated with an object to predict an output state for the object, wherein the output state comprises a plurality of state estimates for a first time period; and generating a state covariance based at least in part on estimated covariance between at least two state estimates of the plurality of state estimates, wherein the state covariance represents an estimated uncertainty associated with the output state.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts example input and output of a deep learning (DL)-based object tracker trained to perform object tracking.

FIG. 2 depicts an example workflow for uncertainty estimation, such as for DL-based object tracking systems.

FIG. 3 depicts example uncertainty associated with sensor measurement(s) used for object tracking and uncertainty estimation.

FIG. 4 depicts an example method for uncertainty estimation.

FIG. 5 depicts an example sensor and computing system.

FIG. 6 depicts aspects of an example device configured to perform uncertainty estimation.

### DETAILED DESCRIPTION

Aspects of the present disclosure provide apparatuses, methods, processing systems, and computer-readable mediums for uncertainty estimation, such as for deep learning (DL)-based object tracking systems. For example, a DL-based object tracking system may be used to predict the output state of an object for a time period in the future. The output state may indicate multiple states (e.g., object properties, such as location, velocity, heading, etc.) predicted for the object for the time period. To quantify the variability and/or uncertainty associated with the predicted output state, a state covariance may be generated. The state covariance may indicate at least the estimated covariance between two estimated states of the object. In certain aspects, the state covariance may comprise a full rank state covariance matrix, which indicates (1) the predicted variance for each estimated object state and (2) the predicted covariance between each pair of estimated object states. The state covariance may be used to evaluate the predicted state output, such as to improve computer vision tasks, that rely on this predicted state output for decision making, for sensor fusion between sensor modalities, scene navigation, and/or the like. Although certain examples herein are described with respect to uncertainty estimation for single object tracking, it is noted that the techniques may be similarly applied to estimate uncertainty associated with DL-based object tracking models for MOT.

Although visual object tracking, such as TBD, has been studied for several decades, and much progress has been made in recent years, TBD remains a technically challenging task. Numerous factors may contribute to the increased difficulty of TBD, including occlusions, object differentiation, such as in densely populated scenes, and/or real-time processing requirements, to name a few.

For example, some visual object tracking systems, which use TBD, may struggle when object(s) become occluded in a frame (e.g., of a sequence of frames). Occlusions can occur in various forms, such as partial occlusions where only a portion of an object is blocked from view, or full occlusion where an entire object is hidden for a period of time (e.g., for one or more frames of the sequence of frames). Occlusions often disrupt the continuity of an object's track, leading to identity switches or track interruptions. For example, when an object is occluded, a tracking system may lose track of the object's identity and thus, assign the object a new identifier for tracking when it reappears. This may lead to fragmented tracks being associated with the same object. In some applications, such as autonomous driving and/or video surveillance, maintaining accurate and consistent object identities may be important for decision making and/or scene understanding.

As another example, some visual object tracking systems, which use TBD, may struggle to perform object tracking for dynamic scenes with numerous, densely-packed objects. For example, due to appearance ambiguity resulting from the dense packing and/or minimal detail resulting from low resolution frames, tracking of individual objects in such scenes may be extremely challenging. These challenges may be particularly common when individually tracking each object in a groups of objects, such as, for example, each pedestrian in a group of pedestrians.

In some cases, MOT may give rise to a large, varying number of detections, and thus tracks that need to be generated, as well as maintenance that needs to be handled for each generated track. For example, track maintenance may include updating a state of an object associated with an existing track each time a new detection is identified (e.g., such as in a current frame) as being associated with the existing track. Performing object tracking (e.g., including generating and maintaining tracks) for a large number of tracks, associated with multiple objects in a scene, may be computationally expensive, and in some cases, it may be impractical to track all objects and maintain each track individually.

To cope with the aforementioned challenges, some deep learning (DL)-based methods have been proposed for object tracking. Deep learning is a subset of machine learning (ML) that uses multilayered neural networks (e.g., artificial neural networks (ANNs)), called deep neural networks (DNNs), to simulate the complex decision-making power of the human brain. For example, deep neural networks consist of multiple layers (hence the adjective “deep”) of interconnected nodes, each building on a previous layer to refine and optimize prediction and/or categorization of the network. This progression of computations through the network is referred to as “forward propagation.” The input layer (e.g., a “visible layer”) is where the deep learning model ingests the data for processing, and the output layer (e.g., another “visible layer”) is where the final prediction or classification is made. Another process referred to as “backpropagation” uses algorithms, such as gradient descent, to calculate errors in predictions, and then adjusts the weights and/or biases of a function by moving backwards through the layers to train the model. Together, forward propagation and backpropagation may enable a neural network to make predictions and correct for any errors. Over time, the algorithm becomes gradually more accurate.

In some cases, DL-based methods are used to aid in performing some of the subtasks for object tracking (e.g., MOT), such as object detection, extracting high-level features from input data, such as frames and/or images, associating new object measurements to existing tracks, managing track initialization/termination, and/or predicting future object states (e.g., including motion), to name a few. In some other cases, DL-based methods are used to solve an MOT task, such as from end-to-end, using DL, with architectures based on extensions of object detectors, convolutional neural networks (CNNs), graph neural networks (GNNs) and/or transformer networks, among others. For example, end-to-end DL-based object tracking methods may learn a mapping from an input state based on a sequence of measurements (e.g., sensor measurements, such as camera, light detection and ranging (LiDAR), radio detection and ranging (RADAR), etc. measurements) to an output state estimate, in a data-driven fashion, thus sidestepping the complexity of dealing with data associations explicitly and the need to resort to heuristics for maintaining computational tractability.

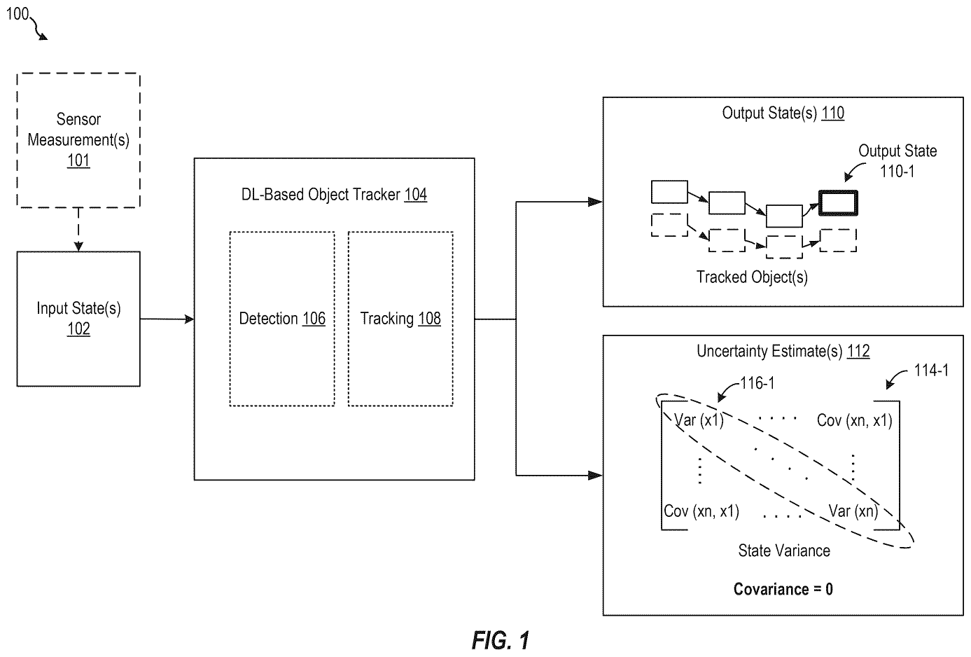

FIG. 1 depicts example input and output of a DL-based object tracker 104 (simply referred to herein as “tracker 104”). The tracker 104 may be trained to solve an end-to-end object tracking task, such as based on performing object detection 106 and tracking 108. In certain aspects, the tracker 104 may perform object detection 106 and tracking 108 for a single object. In certain aspects, the DL-based object tracker 104 may perform object detection 106 and tracking 108 for multiple objects (e.g., MOT).

For example, as shown in FIG. 1, input states 102 may be obtained for multiple objects and provided as input to the tracker 104. The input states 102 may be associated with sensor measurement(s) 101 collected for the objects over a period of time. Sensor measurement(s) 101 may include measurement(s) from one or more sensors, such an image sensor (e.g., camera), a LiDAR sensor, a RADAR sensor, and/or the like. In certain aspects, the input states 102 may represent a trajectory for each of the multiple objects over the period of time. In certain aspects, the input states 102 may be provided as multiple object detections within a sequence of input frames, collected via one or more sensors and associated with the time period. The tracker 104 may detect and localize each of the objects within the input frames, as well as track the detected objects across multiple frames in the frame sequence. In certain aspects, tracker 104 may assign unique identifiers or labels to each object to maintain their identity throughout the tracking process. In certain aspects, the tracker 104 may utilize one or more tracking algorithms to estimate the motion and trajectory of the objects over time, such as to predict an output state, for each object, for a second time period (e.g., later in time or in the future). For example, in certain aspects, tracker 104 may perform end-to-end multiple-object tracking with a transformer. As another example, in certain aspects, tracker 104 may perform 3D object tracking, using a transformer, and estimate predictive trajectory hypotheses. An object's output state 110 may indicate one or more predicted object states (e.g., location, velocity, heading, etc.) for the object for the second time period. In certain aspects, the output state 110 predicted for an object may comprise one or more bounding boxes (e.g., such as shown via example output stat 110-1 in FIG. 1) corresponding to visual representations of the predicted spatial extent(s) of the detected object for the second time period.

In certain aspects, the tracker 104 may additionally provide, as output, uncertainty estimates 112 for the output states 110. For example, an uncertainty estimate 112 per each estimated output state 110 may be provided, as output, from tracker 104. An uncertainty estimate 112 may provide a measure of the reliability of a corresponding output state 110 predicted by tracker 104. Put differently, an uncertainty estimate 112 may quantify the degree of uncertainty associated with a corresponding output state 110 predicted by tracker 104.

Uncertainty estimation for deep neural networks is a technique used to target the variance of DL-based models, as well as their overconfidence. For example, uncertainty in a DL-based model may be produced by two main sources, namely from data, known as “aleatoric uncertainty,” and from the DL model, known as “epistemic uncertainty.” More specifically, aleatoric uncertainty defines the stochasticity and noise that is inherently present in the data. This uncertainty may be introduced by sensors and/or the environment, and it may be irreducible (e.g., meaning that this uncertainty cannot be decreased by increasing the amount of gathered data). Epistemic uncertainty, on the other hand, describes the uncertainty in the DL model's parameters and/or the uncertainty due to the DL model's inherent limitations, such as in domains where training data is not available.

The importance of uncertainty estimation in object tracking extends to a wide range of computer vision applications where reliability may be critical. For example, in autonomous driving and/or robotic navigation, the consequences of an incorrect prediction, such as the incorrect prediction of a location of one or more objects in a scene, may be severe. By obtaining estimates of uncertainty, not only can the reliability of a predicted output state for an object in a scene be evaluated, but cases where a model is less than confident about a predicted output state may be flagged. This additional information may help to improve decision making, allow for safer navigation through an environment, and/or, in some cases, help to avoid a range of bad outcomes (e.g., vehicular crashes, loss of life, etc.), to name a few.

An uncertainty estimate, provided by a DL-based object tracker, generally includes information about a variance of each variable in an output of the DL system. However, the correlation of different variables in the output, also referred to herein as the “covariance” between two variables, remains untracked. For example, the DL-based object tracker may produce a covariance matrix (also often referred to as a “variance-covariance matrix”) as output for each output state predicted by the tracker, such as the example matrix 114-1, shown in FIG. 1, produced by tracker 104 for output state 110-1. The covariance matrix is a square matrix including multiple elements. The diagonal elements of the covariance matrix (e.g., shown via 116-1 in FIG. 1) may indicate the variances determined for each of the variables of the corresponding output state, while the off-diagonal elements may indicate the covariances between all possible pairs of variables of the corresponding output state.

As used herein, variance is a measure of the variability or spread of data within a single variable. Mathematically, it is the average squared deviation from the mean of that variable. Thus, variance may indicate how much the values in that variable deviate from their mean, with a higher variance indicating greater spread and a lower variance indicating data points closer to the mean. Further, as used herein, covariance measures the directional relationship between two variables in an output of the DL system. For example, the covariance between two variables can be positive, negative, or zero. A positive covariance indicates that the two variables have a positive relationship whereas negative covariance shows that they have a negative relationship. If two elements do not vary together then they will display a zero covariance.

As described above, the DL-based object tracker may not determine the correlation of different variables in the output state, and thus may assume that the covariance between variable pairs (e.g., pairs of state estimates) is zero. Thus, the covariance between pairs of variables in a corresponding output state may be assumed to be equal to zero. For example, an output state predicted for an object may include a predicted location, heading, and velocity of the object for a time period. The DL-based object tracker may determine a variance for the location, a variance for the heading, and a variance for the velocity (e.g., determine variances for variables of the output state). The DL-based object tracker, however, may not determine a covariance between location and heading, a covariance between location and velocity, nor a covariance between heading and velocity. Instead, the DL-based object tracker may assume that the covariances are equal to zero (e.g., such as illustrated by the off-diagonal covariance values in example covariance matrix 114-1 shown in FIG. 1, which are equal to zero).

Both variance and covariance information may help in having a comprehensive understanding of the uncertainty associated with an output of a DL-based object tracker, such as a predicted output state for an object. For example, covariance information may quantify relationships between states predicted for an object (e.g., provided as variables of an output state predicted by the tracker), revealing how their uncertainties are interconnected and should be considered when using tracker output for downstream tasks. Thus, uncertainty estimations, absent covariance information, may fail to provide an accurate evaluation of the DL-based object tracker's predicted output, thereby limiting its value for downstream tasks that rely on this output for prediction, planning, control, and/or the like. Thus, a technical challenge associated with using DL-based object trackers includes their inability to produce covariance information for comprehensive uncertainty estimation. Further, to realize the benefits of DL-based object tracking systems, these systems may need to be able to compete with/replace traditional tracking techniques (e.g., such as applied in current generation vision stacks) which are capable of complete uncertainty estimation, which is currently absent from the DL-based object tracker output, as described in detail above.

Certain aspects described herein overcome the aforementioned technical problems associated with uncertainty estimation when using a DL-based object tracker for single object tracking and/or MOT, and provide a technical benefit to the field of computer vision. For example, aspects described herein provide techniques for estimating the state covariance associated with an object's output state predicted by a DL-based object tracker. The state covariance may represent an estimated uncertainty associated with the output state. The state covariance may include an estimated covariance between at least two state estimates of the output state predicted by the DL-based object tracker, and in some cases, may include an estimated covariance between all pairs of state estimates of the output state.

In certain aspects, a Kalman filter is used in combination with the DL-based object tracker to generate the state covariance. A Kalman filter is a probabilistic tool for estimating the state of dynamical systems in a continuous or discretized time domain. As described herein, the Kalman filter may be used to only perform the covariance estimation (without estimating an object's output state). That is, the DL-based object tracker may be used to generate the output state for an object, and the Kalman filter may generate a state covariance for the output state predicted by the tracker, such that one or more covariances between states estimated by the tracker for the object are estimated instead of being assumed to be equal to zero (e.g., the above-described technical problem associated with using a DL-based object tracker alone for uncertainty estimation). In certain aspects, the output of the Kalman filter is a state covariance matrix including (1) predicted variances for each state estimate associated with the output state and (2) at least one predicted covariance between a state estimate pair (or predicted covariances between all state estimate pairs, such that a full rank covariance matrix is generated). The predicted variances may make up the diagonal elements of the matrix, while the off-diagonal element(s) of the matrix may include the predicted covariance(s).

The techniques described herein may provide various beneficial technical effects and/or advantages, such as an ability to utilize and realize (1) the benefits provided by DL-based object tracking systems with respect to object tracking and (2) the benefits achieved when using a Kalman filter for uncertainty estimation. For example, DL-based object tracking systems provide various beneficial technical effects and/or advantages over conventional solutions (e.g., TBD solutions), such as robust tracking performance of diverse objects in real-world environments, even in the presence of challenging conditions such as occlusions and/or and crowded scenes. In certain aspects, the improved tracking performance of such systems may be attributable to the ability of DL-based object tracking models to achieve longer context-based tracking. Further, a Kalman filter provides various beneficial technical effects and/or advantages over conventional solutions for uncertainty estimation (e.g., DL-based systems for uncertainty estimation), such as an ability to provide a comprehensive understanding of the uncertainty associated with an output of a DL-based object tracker without being computationally expensive. As such, output state and state covariance predictions may be more accurate for downstream use. For example, output state(s) of the DL-based object tracker may be utilized for path planning, which is important task in autonomous driving systems to maintain safety. The uncertainty estimate for the output state(s), via the Kalman filter, may help to provide insight into whether or not, and/or how much, the output state(s) of the DL-based object tracker may be relied on for safely navigating the autonomous vehicle through an environment.

### Example Workflow for Uncertainty Estimation

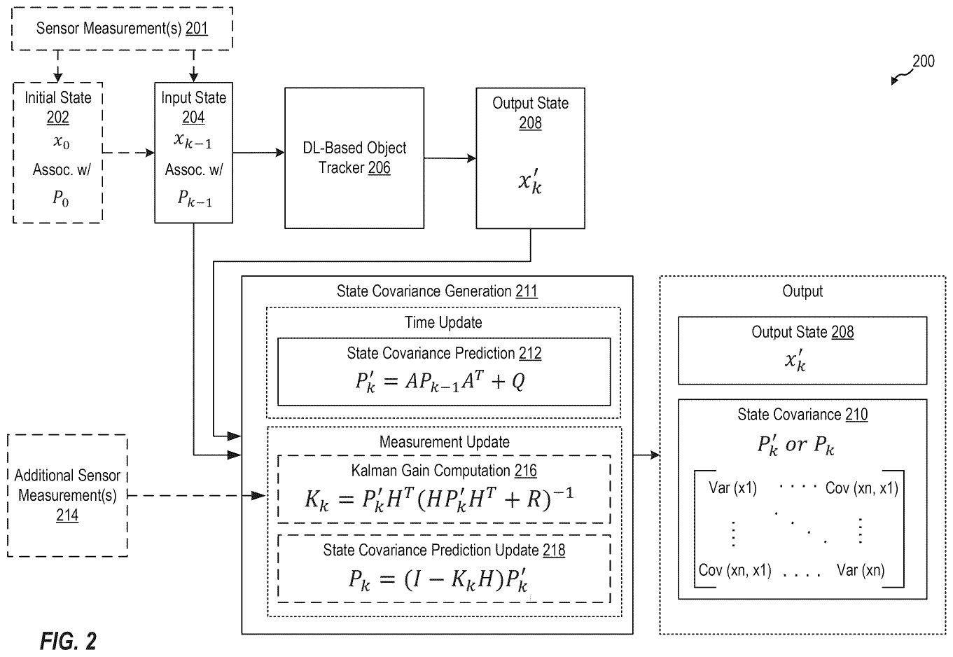

FIG. 2 depicts an example workflow 200 for uncertainty estimation, such as for DL-based object tracking systems. More specifically, workflow 200 may be used to generate an output state 208 for an object (e.g., an object in an environment, such as a vehicle, a pedestrian, a cyclist, etc.). The output state 208 may be generated based on a DL-based object tracker 206 (simply referred to herein as a “tracker 206”) processing an input state 204 for the object, associated with a first period of time. The output state 208 may include states estimated for the object for a second period of time (e.g., a future time period, later in time than the first period of time). Workflow 200 may further be used to generate a state covariance 210 for the output state 208, representing the uncertainty associated with the output state 208 generated by the tracker 206. The state covariance 210 may include covariance values estimated for one or more pairs of state estimates predicted for the object (and included as part of output state 208). The output state 208 and the state covariance 210 may be provided as output, and in some cases, used in one or more downstream tasks, such as object fusion (e.g., the process of combining data from multiple sensors to create a more accurate understanding of the vehicle's surroundings), automatic energy breaking (e.g., used to identify when a possible collision is about to occur and respond by autonomously activating the brakes of a vehicle to slow the vehicle prior to impact or bring the vehicle to a stop to avoid a collision), and/or driving policy (e.g., driving policy is a set of algorithms used to teach autonomous vehicles to negotiate like humans), to name a few.

Although workflow 200 in FIG. 2 is used to generate an output state 208 and a corresponding state covariance 210 for a single object, in some other examples, workflow 200 may be similarly used to generate output states 208 for multiple objects (e.g., perform MOT) and corresponding state covariances 210 for the multiple objects (e.g., one state covariance 210 for each output state 208 predicted for each object).

Similar to workflow 100 depicted and described with respect to FIG. 1, workflow 200 in FIG. 2 begins with obtaining an input state 204 for the object, which may be processed by tracker 206. The input state 204 for the object may be represented as the variable xₖ₋₁, as shown in FIG. 2. The input state 204 may be associated with sensor measurement(s) 201 collected for the object over the first period of time. Sensor measurement(s) 201 may include measurement(s) from one or more sensors, such an image sensor (e.g., camera), a LiDAR sensor, a RADAR sensor, and/or the like. In certain aspects, the input state 204 may represent a trajectory for the object over the first period of time.

In certain aspects, the input state 204 may be provided as multiple object detections within a sequence of input frames, collected via one or more sensors, associated with the first time period. For example, the sequence of input frames may include two or more frames, such as a sequence of frames from a video, frames from a scene captured by a LiDAR sensor, fused frames combining information from multiple sensors, and/or any other suitable type of frame data. The frames may be obtained from various sources, such as video sequences captured by image sensors (e.g., cameras), frames from a scene provided by one or more LiDAR sensors, etc. In certain aspects, the frames may include 3D frames or 3D representations, such as 3D point clouds (simply referred to herein as “point clouds”). For example, 3D sensor(s), such as LiDAR sensor(s), may be used to produce point clouds, which are collections of points (e.g., associated with objects) in 3D space for a scanned environment. In certain aspects, the sequence of input frames may include 2D frames or 2D representations, such as 2D images. For example, image sensor(s), such as camera(s), may be used to produce 2D images, which include pixels in 2D space for a scanned environment. The frames may include depictions of at least the object. In certain aspects, the frames may capture depictions of at least the object in dynamic, real-world scene over the first time period. In certain aspects, a convolutional neural network (CNN) may be used to generate the object detections from the frames. In certain aspects, an object detection model, such as You Only Look Once (YOLOX), may be used to generate the object detections from the frames.

Input state 204 (xₖ₋₁) may be associated with state covariance, represented as variable Pₖ₋₁ in FIG. 2. In cases where workflow 200 has not been performed previously, input state 204 xₖ₋₁=x₀ and state covariance Pₖ₋₁=P₀, where x₀ is an initial state 202 of the object and P₀ is an initial state covariance initialized/assumed for the object. In cases where workflow 200 has been performed previously, input state 204 xₖ₋₁ may represent a previous state predicted for the object (e.g., a previous output state 208), and state covariance Pₖ₋₁ may represent a state covariance generated for the previous state predicted for the object. The state covariance (Pₖ₋₁) associated with input state 204 (xₖ₋₁) may represent an (estimated) uncertainty associated with input state 204.

Workflow 200 then proceeds with tracker 206 processing input state 204 to generate output state 208. For example, tracker 206 may perform object detection to detect at least the object in the input provided to tracker 206. A detection may refer to the identification and localization of the object, or its input state 204, within the input provided to tracker 206. Tracker 206 may analyze visual and depth information to identify and localize the object within a scene captured by the input processed by tracker 206. This identification can be represented by various data types, such as by bounding boxes, points, or clusters, depending on the sensor modality and/or the specific application. Thus, a detection may be a flexible concept that applies to various sensor modalities and data representations. In certain aspects, each detection, associated with the object, may be associated with one or more states. Example states associated with a detection of the object may include a center of a bounding box associated with the object; a location of the object; an orientation of the object; a heading of the object; a size of the object; a velocity of the object; or an acceleration of the object, to name a few.

As an illustrative example, where the tracker 206 processes a sequence of frames, including 2D images, a detection may be represented by a bounding box that encloses the detected object. The bounding box may be defined by its coordinates, which specify the object's position within one of the images.

In addition to object detection, tracker 206 may also perform object tracking. Object tracking may result in the generation of a track associated with the object. The track may include a respective sequence of detections, and more specifically, a respective sequence of states associated with the sequence of detections for the object. The respective sequence of states may represent a respective trajectory for the object.

In certain aspects, the tracker 206 may utilize one or more tracking algorithms to estimate the motion and trajectory of the object over the first period of time, such as to predict the output state 208 for the object. The output state 208 may be represented as variable

$${x}_{k}^{′}$$

as shown in FIG. 2. The object's output state 208 may indicate one or more predicted states (e.g., location, velocity, heading, etc.) for the object for the second time period.

Workflow 200 then proceeds with state covariance generation 211 to generate state covariance 210 for output state 208. In certain aspects, state covariance generation 211 include generating state covariance 210 based on a Kalman filter. In certain aspects, state covariance 210 generated using the Kalman filter comprises a state covariance matrix representing an estimated uncertainty associated with output state 208. As such, instead of tracker 206 generating state covariance 210 for output state 208, similar to workflow 100 shown in FIG. 1, a Kalman filter is used to generate the state covariance 210. The Kalman filter may allow for the prediction of both (1) variances and (2) covariances for estimates states associated with output state 208.

As shown in FIG. 2, state covariance generation 211 begins with state covariance prediction 212. State covariance prediction estimates state covariance

$${P}_{k}^{′}$$

based on the equation:

$${P}_{k}^{′} = A {P}_{k - 1} {A}^{T} + Q$$

where variable A represents a state transition matrix, variable Pₖ₋₁ represents the covariance associated with the input state 204 (xₖ₋₁), and variable Q represents a process covariance matrix.

The state transition matrix, A, describes how the object's states propagate with time given input state 204. In certain aspects, the state transition matrix, A, may be generated based on a constant velocity motion model, a constant acceleration motion model, a Singer model, an Alpha-Beta model, a coordinated turn motion model, or a constant turn rate motion model. A singer model, when used to generate the state transition matrix, A, may assume that the input noise is low-pass filtered. The Alpha-Beta model may be used to estimate the position and velocity of the object.

In certain other aspects, the state transition matrix, A, may be calculated based on a least squares means method, the input state 204 (xₖ₋₁), and the output state 208 (xₖ). For example, state transition matrix, A, may be calculated based on the equation:

$${x}_{k} = A {x}_{k - 1}$$

In certain aspects, multiple (xₖ, xₖ₋₁) pairs representing the output states 208 and input states 204, respectively, from tracker 206 may be used to calculate the state transition matrix, A. For example, a least squares fit solution may be used to fit state transition matrix, A, for the multiple (xₖ, xₖ₋₁) pairs.

The process covariance matrix, Q, quantifies the uncertainty associated with the DL-based object tracking system's internal state transitions, essentially describing how much “noise” is added to the object's state during its propagation. In certain aspects, process covariance matrix, Q, is derived using a Kalman filter autotuning method, such as a normalized estimation error squared (NEES) method or a normalized innovation squared (NIS) method. In either case, the process covariance matrix, Q, may also be derived based on an unbiased filter. An unbiased filter may be a filter that does not underestimate, nor overestimate. In order to have an unbiased filter, the process covariance matrix Q (e.g., noise) to be accurately reflected. NEES and NIS are statistical techniques which may be used to evaluate and/or tune the performance of a Kalman filter, particularly in determining the process covariance matrix Q. An NEES/NIS value within a certain range, may indicate that the filter is well-tuned. Alternatively, an NEES/NIS value outside of the certain range, such as higher than the range, may suggest that the process covariance matrix Q (e.g., noise) may be underestimated, thereby leading to overconfidence in the state estimates, and vice versa when the NEES/NIS value is lower than the range.

In some examples, a Kalman filter may have bias. Further, other methods, such as more complicated methods including a Particle filter, may have less bias. The best nonlinear filter may be used to estimate the true process covariance matrix Q.

In certain aspects, the state covariance

$${P}_{k}^{′} ,$$

estimated during state covariance prediction 212, becomes the state covariance 210 provided as output. The state covariance

$${P}_{k}^{′}$$

may include an estimated covariance between at least two state estimates of the output state 208. For example, if output state 208 represents a predicted location and velocity of the object at the second time period. Then the state covariance

$${P}_{k}^{′}$$

may include an estimated covariance between the predicted location and velocity of the object at the second time period. In certain aspects, the state covariance

$${P}_{k}^{′} ,$$

provided as state covariance 210 output, comprises a state covariance matrix.

In certain other aspects, the state covariance

$${P}_{k}^{′} ,$$

estimated during state covariance prediction 212, may be updated based on one or more additional sensor measurements 214 for the object. Additional sensor measurement(s) 214 may include image sensor, LiDAR, RADAR, etc. measurements for the object. Additional sensor measurement(s) 214 may include measurement(s) collected or obtained for the object after a time when the sensor measurement(s) 201 were obtained for the object.

For example, after state covariance prediction 212, state covariance generation 211 may proceed with Kalman gain computation 216. Kalman gain computation 216 may involve the generation of a matrix that determines how much weight should be given to the additional sensor measurement(s) 214 and the current state estimates (e.g., output state 208) in the Kalman filter. The Kalman gain, Kₖ, may be calculated based on the equation:

$${K}_{k} = {P}_{k}^{′} {{H}_{k}^{T} ( {H}_{k} {P}_{k}^{′} {H}_{k}^{T} + {R}_{k} )}^{- 1}$$

where variable Hₖ represents an observation matrix, variable

$${P}_{k}^{′}$$

represents the state covariance estimated during state covariance prediction 212, and variable Rₖ represents a measurement noise covariance matrix.

The observation matrix, Hₖ, is used to transform the output state 208 (e.g., the predicted state estimates for the object) from the state space to a measurement space. The observation matrix, Hₖ, may be used to bridge the gap between the state space and the measurement space. For example, the state of an object may be a 3D point (e.g. x, y, z coordinates) and a measurement may include a 2D pixel (e.g., u, v coordinates). The observation matrix, Hₖ, may transform the state in 3D to 2D in order for it to be compared against the measurements which are in 2D.

For example, a state transition model describes how a state evolves over time. It is given by the equation:

$${x}_{k + 1} = f ( {x}_{k} , {u}_{k} ) + {w}_{k}$$

where ƒ is a nonlinear function, xₖ is the state at time k, uₖ is the control input, and wₖ is the process noise. A measurement model describes how sensor measurements (e.g., such as additional sensor measurement(s) 214) are related to the state. It is given by the equation:

$${z}_{k} = h ( {x}_{k} ) + {v}_{k}$$

where h is a nonlinear function, zₖ is the measurement at time k, and vₖ is the measurement noise. To apply the Kalman Filter equations, an EKF may linearize the nonlinear functions ƒ and h around the current state estimate using a first-order Taylor series expansion. This may involve calculating the Jacobians of nonlinear functions ƒ and h around:

$${{f}_{k} = \frac{\partial f}{\partial x} \vert}_{x = {\hat{x}}_{k \vert k} , {u}_{k}}$$

$${{H}_{k} = \frac{\partial h}{\partial x} \vert}_{x = {\hat{x}}_{k \vert k - 1}}$$

where Fₖ is the Jacobian of the state transition function and Hₖ is the Jacobian of the measurement function.

The state and covariance are predicted using the nonlinear state transition function given by the equations:

$${\hat{x}}_{k + 1 \vert k} = f ( {\hat{x}}_{k \vert k} , {u}_{k} )$$

$${P}_{k + 1 \vert k} = {F}_{k} {P}_{k \vert k} {F}_{k}^{T} + {Q}_{k}$$

where Pₖ is the state covariance matrix and Qₖ is the process noise covariance matrix.

The state and covariance are updated using the nonlinear measurement function given by the equations:

$${K}_{k} = {P}_{k \vert k - 1} {{H}_{k}^{T} ( {H}_{k} {P}_{k \vert k - 1} {H}_{k}^{T} + {R}_{k} )}^{- 1}$$

$${\hat{x}}_{k \vert k} = {\hat{x}}_{k \vert k - 1} + {K}_{k} ( {z}_{k} - h ( {\hat{x}}_{k \vert k - 1} ) )$$

$${P}_{k \vert k} = ( I - {K}_{k} {H}_{k} ) {P}_{k \vert k - 1}$$

where Kₖ is the Kalman gain, Rₖ is the measurement noise covariance, and I is the identity matrix.

In summary, the EKF uses nonlinear functions to describe the relationship between the state x and the measurement z, and linearizes these functions around the current state estimate to apply the Kalman Filter equations.

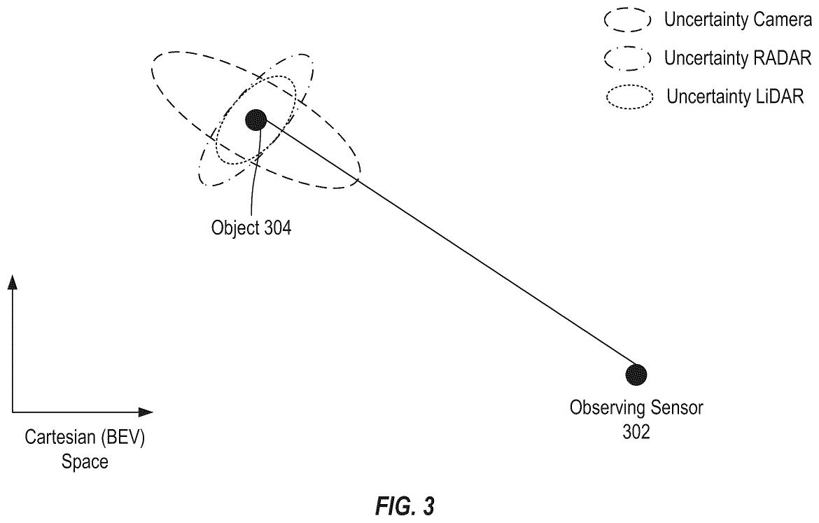

The measurement noise covariance matrix, R, describes how much random noise is present in each additional sensor measurement 214, and the correlation between different additional sensor measurements 214. The random noise present in each of additional sensor measurement(s) 214, thereby affecting the uncertainty of such additional sensor measurement(s) 214, may be a function of the particular sensor(s) used to obtain the additional sensor measurement(s) 214. For example, as shown in FIG. 3, an observing sensor 302 used to observe and provide sensor measurement(s) for an object 304 may include an image sensor, such as a camera, a RADAR, and/or a LiDAR. An uncertainty associated with additional sensor measurement(s) 214 obtained by the camera may be different than uncertainty associated with additional sensor measurement(s) 214 obtained by the LiDAR, which may also be different than the uncertainty associated with additional sensor measurement(s) 214 obtained by the RADAR. The uncertainty associated with the sensor measurement(s) obtained by the observing sensor 302 (e.g., the camera, LiDAR, or RADAR) may be directly proportional, for instance, to a range between the observing sensor 302 and the object 304, an angle between the observing sensor 302 and the object 304. Furthermore, additional attribute(s) of the observing sensor 302, such as a range-rate (e.g., Doppler speed, which may be output by a radar or output by a LiDAR sensor, for example) and/or an angular-rate, may be modeled and used in this context. For example, the uncertainty associated with a sensor maybe a function of where the sensor and the object are. Different ways of calculating this uncertainty may include using the distance between the sensor and the object (e.g., range) or the angle between them. Accordingly, the measurement noise may be a factor of the range rate (e.g., the rate of change of the range/distance) and/or the angular-rate (e.g., the rate of change of the angle) between the sensor and the object.

Using the Kalman gain, Kₖ, computed during Kalman gain computation 216, state covariance prediction update 218 may be performed. For example, state covariance prediction update 218 may be used to update the state covariance

$${P}_{k}^{′} ,$$

estimated during state covariance prediction 212, using the Kalman gain, Kₖ, computed during Kalman gain computation 216. The updated state covariance, Pₖ, may be calculated based on the equation:

$${P}_{k} = ( I - {K}_{k} H ) {P}_{k}^{′}$$

where variable Kₖ represents the Kalman gain, variable H represents the observation matrix, variable I represents an identity matrix, and variable

$${P}_{k}^{′}$$

represents the state covariance estimated during state covariance prediction 212.

In certain aspects, the identity matrix, I, is a square matrix of dimension n×n (e.g., where n is the size of the output state xₖ) with ones on its diagonal and zeros everywhere else.

In certain aspects, the state covariance Pₖ, estimated during state covariance prediction update 218, becomes the state covariance 210 provided as output. The state covariance Pₖ may include an estimated covariance between at least two state estimates of the output state 208. In certain aspects, the state covariance Pₖ, provided as state covariance 210 output, comprises a state covariance matrix.

In certain aspects, state output 208 and state covariance 210, estimated/predicted for the object may be used for one or more downstream tasks. For example, an agent (not shown), which is an element or entity of, or in communication with, the DL-based object tracking system, may utilize the state output 208 and state covariance 210 output by workflow 200. The agent may be an autonomous vehicle, a robot, a device, or any other intelligent system that leverages the state output 208 and state covariance 210, such as for navigation and/or decision-making. For example, where the agent is an autonomous vehicle, then the agent may use the state output 208 and state covariance 210 for the object (or state outputs 208 and state covariances 210 for multiple object) to navigate in its environment. As another example, if the agent is a robot, then the agent may use the use the state output 208 and state covariance 210 for the object (or state outputs 208 and state covariances 210 for multiple object) to select the best path to take in its environment, such as based on its current goals, and execute this selection. In some other examples, the state output 208 and state covariance 210 may be used for sensor/object fusion, automatic emergency braking (e.g., simpler), and/or driving policy (e.g., more advanced), among others applications.

In certain aspects, the state output 208 and state covariance 210 may be used in downstream tasks in autonomous driving, like path planning and control. For example, the state output 208 and state covariance 210 may provide information about the location of an object, along with other information for the object, such as its motion, shape, and/or size information, as well as its covariance. Using the state covariance 210, a best path for an autonomous vehicle to traverse in an environment may be determined. For example, if the covariance values of state covariance 210 are low, indicating that the tracker is confident about its output (e.g., confident about state output 208), then a path may be confidently chosen in order to avoid colliding into this object.

### Example Method for Uncertainty Estimation

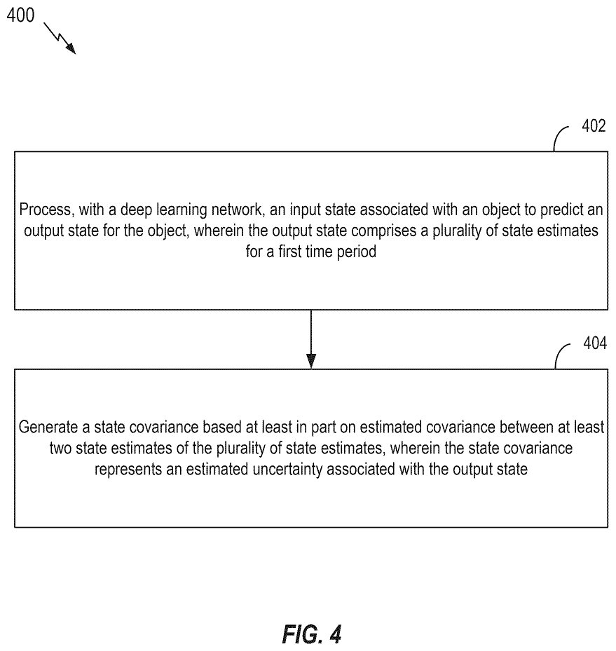

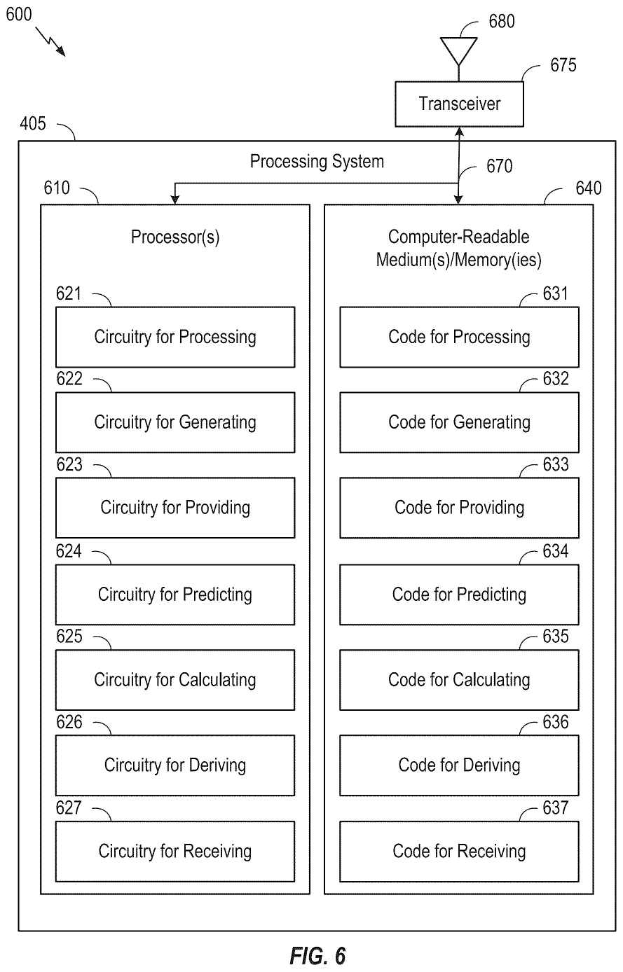

FIG. 4 depicts an example method 400 for uncertainty estimation. In certain aspects, method 400, or any aspect related to it, may be performed by an apparatus, such as device 600 of FIG. 6, which includes various components operable, configured, or adapted to perform the method 400.

Method 400 begins a block 402 with processing, with a deep learning network, an input state associated with an object to predict an output state for the object, wherein the output state comprises a plurality of state estimates for a first time period.

Method 400 proceeds at block 404 with generating a state covariance based at least in part on estimated covariance between at least two state estimates of the plurality of state estimates, wherein the state covariance represents an estimated uncertainty associated with the output state.

In certain aspects, method 400 further includes providing as output the output state and the state covariance.

In certain aspects, the estimated covariance between at least the two state estimates is not equal to zero.

In certain aspects, generating, at block 404, the state covariance comprises generating a full rank state covariance matrix based on a respective estimated covariance between each pair of state estimates of the plurality of state estimates.

In certain aspects, generating, at block 404, the state covariance comprises generating a state covariance matrix based on a Kalman filter.

In certain aspects, generating, at block 404, the state covariance matrix based on the Kalman filter comprises: predicting the state covariance matrix based on: a state transition matrix, a previous state covariance matrix associated with a second time period prior in time to the first time period, and a process covariance matrix.

In certain aspects, method 400 further includes generating the state transition matrix based on at least one of: a constant velocity motion model; a constant acceleration motion model; a Singer model; an Alpha-Beta model; a coordinated turn motion model; or a constant turn rate motion model.

In certain aspects, method 400 further includes calculating the state transition matrix based on a least squares means method, the input state, and the output state.

In certain aspects, method 400 further includes deriving the process covariance matrix based on an unbiased filter that is based on a normalized estimation error squared method or a normalized innovation squared method.

In certain aspects, the previous state covariance matrix comprises an initial state covariance matrix.

In certain aspects, method 400 further includes: receiving, via one or more sensors, one or more sensor measurements for the object; and generating an observation matrix based on the one or more sensor measurements, wherein generating the state covariance matrix based on the Kalman filter further comprises: computing a Kalman gain based on: the state covariance matrix; the observation matrix; and a measurement noise covariance matrix; and updating the state covariance matrix based on: the observation matrix; and the Kalman gain.

In certain aspects, the measurement noise covariance matrix is based on at least one of noise associated with the one or more sensor measurements or the one or more sensors.

In certain aspects, the one or more sensors comprise a first sensor; and the measurement noise covariance matrix is based on at least one of a range, an angle, a range-rate, or an angular-rate associated with the first sensor.

In certain aspects, the plurality of state estimates comprise two or more of: a center of a bounding box associated with the object; a location of the object; an orientation of the object; a heading of the object; a size of the object; a velocity of the object; or an acceleration of the object.

In certain aspects, the input state is based on one or more sensor measurements associated with the object for a second time period.

Note that FIG. 4 is just one example of a method, and other methods including fewer, additional, or alternative steps are possible consistent with this disclosure.

### Example Sensor and Computing System for Uncertainty Estimation

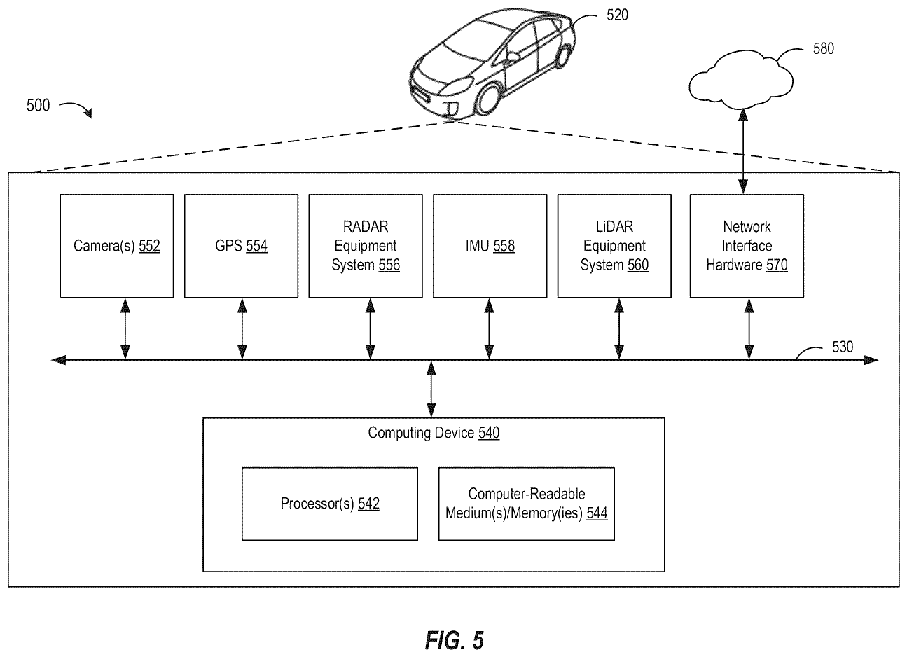

FIG. 5 depicts an example sensor and computing system 500 equipped, for example, in a vehicle 520 or other apparatus, such as a robot. The vehicle 520 depicted in FIG. 5 is depicted by way of an example schematic of a vehicle including sensor resources and a computing device. Not every vehicle may be required to be equipped with the same set of sensor resources, nor may every vehicle be required to be configured with the same set of systems for perceiving attributes of an environment. FIG. 5 only provides one example configuration of sensor resources and systems equipped within a vehicle 520. It is understood that aspects described herein are made with reference to implementation with, on, or in a vehicle 520. However, this is merely an example. The vehicle 520 may be any other apparatus.

In particular, FIG. 5 provides an example schematic of the vehicle 520 including a variety of sensor resources, which may be utilized, by the vehicle 520 to perceive and collect sensor data about the environment. For example, the vehicle 520 may include a computing device 540 comprising one or more processors 542 and one or more non-transitory computer readable medium(s)/memory(ies) 544, one or more cameras 552, a global positioning system (GPS) 554, a RADAR equipment system 556, an inertial measurement unit (IMU) 558, a LiDAR equipment system 560, and network interface hardware 570.

In certain aspects, the vehicle 520 may not include all of the components depicted in FIG. 5. In certain aspects, the vehicle 520 may include one or more of the components, such as the one or more of the cameras 552, one or more of the GPS 554, one or more of the RADAR equipment system 556, one or more of the IMU 558, one or more of the LiDAR equipment system 560, one or more of a SONAR system, and/or the like. These and other components of the vehicle 520 may be communicatively connected to each other via a communication path 530.

The communication path 530 may be formed from any medium that is capable of transmitting a signal such as, for example, conductive wires, conductive traces, optical waveguides, or the like. The communication path 530 may also refer to the expanse in which electromagnetic radiation and their corresponding electromagnetic waves traverses. Moreover, the communication path 530 may be formed from a combination of mediums capable of transmitting signals. In one embodiment, the communication path 530 comprises a combination of conductive traces, conductive wires, connectors, and buses that cooperate to permit the transmission of electrical data signals to components such as processors, memories, sensors, input devices, output devices, and communication devices. Accordingly, the communication path 530 may comprise a bus. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. As used herein, the term “communicatively coupled” means that coupled components are capable of exchanging signals with one another such as, for example, electrical signals via conductive medium, electromagnetic signals via air, optical signals via optical waveguides, and the like.

The computing device 540 may be any device or combination of components comprising one or more processors 542 and one or more non-transitory computer readable medium(s)/memory(ies) 544. The one or more processors 542 may be any device(s) capable of executing the processor-executable instructions stored in the one or more non-transitory computer readable medium(s)/memory(ies) 544. For example, each of the one or more processors 542 may be an electric controller, an integrated circuit, a microchip, a computer, or any other computing device. The one or more processors 542 are communicatively coupled to the other components of the vehicle 520 by the communication path 530. Accordingly, the communication path 530 may communicatively couple any number of processors 542 with one another, and allow the components coupled to the communication path 530 to operate in a distributed computing environment. Specifically, each of the components may operate as a node that may send and/or receive data.

The one or more non-transitory computer readable medium(s)/memory(ies) 544 may comprise RAM, ROM, flash memories, hard drives, or any non-transitory memory device capable of storing processor-executable instructions such that the processor-executable instructions can be accessed and executed by the one or more processors 542. The machine-readable instruction set may comprise logic or algorithm(s) written in any programming language of any generation (e.g., 1GL, 2GL, 3GL, 4GL, or 5GL, where GL stands for “generation language”) such as, for example, machine language that may be directly executed by the one or more processors 542, or assembly language, object-oriented programming (OOP), scripting languages, microcode, etc., that may be compiled or assembled into processor-executable instructions and stored in the one or more memories 544. Alternatively, the processor-executable instructions may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components.

The vehicle 520 may further include one or more cameras 552. The one or more cameras 552 may be any device having an array of sensing devices (e.g., a charge-coupled device (CCD) array or active pixel sensors) capable of detecting radiation in an ultraviolet wavelength band, a visible light wavelength band, or an infrared wavelength band. The one or more cameras 552 may have any resolution. The one or more cameras 552 may be an omni-direction camera and/or a panoramic camera. In certain aspects, one or more optical components, such as a mirror, fish-eye lens, and/or any other type of lens may be optically coupled to the one or more cameras 552. The image data collected by the one or more cameras 552 may be stored in the one or more non-transitory computer readable medium(s)/memory(ies) 544.

GPS 554, may be coupled to the communication path 530 and communicatively coupled to the computing device 540 of the vehicle 520. The GPS 554 is capable of generating location information indicative of a location of the vehicle 520 by receiving one or more GPS signals from one or more GPS satellites. The GPS signal communicated to the computing device 540 via the communication path 530 may include location information including a message, a latitude and longitude data set, a street address, a name of a known location based on a location database, and/or the like. Additionally, the GPS 554 may be interchangeable with any other system capable of generating an output indicative of a location. For example, a local positioning system that provides a location based on cellular signals and broadcast towers or a wireless signal detection device capable of triangulating a location by way of wireless signals received from one or more wireless signal antennas. The sensor data collected by the GPS 554 may be stored in the one or more non-transitory computer readable medium(s)/memory(ies) 544.

RADAR equipment system 556 measures the distance to objects over wide distances. It is also possible to measure the relative speed of the detected object. The RADAR equipment system 556 may be a continuous wave (CW), frequency-modulated continuous wave (FMCW), 3D-radio detection and ranging equipment (3D FMCW multiple-input and multiple-output (MIMO)), or 4D-radio detection and ranging equipment (4D FMCW MIMO). The sensor data collected by the RADAR equipment system 556 may be stored in the one or more non-transitory computer readable medium(s)/memory(ies) 544.

IMU 558 is an electronic device that measures and reports vehicle 520's specific force, angular rate, and/or the orientation of the vehicle 520, using a combination of accelerometers, gyroscopes, and/or magnetometers. The sensor data collected by the IMU 558 may be stored in one or more non-transitory computer readable medium(s)/memory(ies) 544.

LiDAR equipment system 560 is communicatively coupled to the communication path 530 and the computing device 540. LiDAR equipment system 560 may be a system and method of using pulsed laser light to measure distances from the LiDAR equipment system 560 to objects that reflect the pulsed laser light. A LiDAR equipment system 560 may be made as solid-state devices with few or no moving parts, including those configured as optical phased array devices where its prism-like operation permits a wide field-of-view without the weight and size complexities associated with a traditional rotating light detection and ranging equipment system 560. LiDAR equipment system 560 may be particularly suited to measuring time-of-flight, which in turn may be correlated to distance measurements with object(s) that are within a field-of-view of the LiDAR equipment system 560. By calculating the difference in return time of the various wavelengths of the pulsed laser light emitted by the LiDAR equipment system 560, a digital 3D representation of an object and/or or environment may be generated. The pulsed laser light emitted by the LiDAR equipment system 560 may include emissions operated in and/or near the infrared range of the electromagnetic spectrum, for example, having emitted radiation of about 905 nanometers. Vehicle 520 may use LiDAR equipment system 560 to provide detailed 3D spatial information for the identification of object(s) near the vehicle 520, as well as the use of such information in the service of systems for vehicular mapping, navigation and autonomous operations. In certain aspects, point cloud data collected by the LiDAR equipment system 560 may be stored in the one or more non-transitory computer readable medium(s)/memory(ies) 544. In certain aspects, LiDAR equipment system 560 may provide Doppler speed/range-rate.

In certain aspects, vehicle 520 may be equipped with a vehicle-to-vehicle (V2V) communication system, which may rely on network interface hardware 570. The network interface hardware 570 may be coupled to the communication path 530 and communicatively coupled to the computing device 540. The network interface hardware 570 may be any device capable of transmitting and/or receiving data with a network 580 and/or directly with another vehicle equipped with a V2V communication system. Accordingly, network interface hardware 570 can include a communication transceiver for sending and/or receiving any wired and/or wireless communication. For example, the network interface hardware 570 may include an antenna, a modem, a local area network (LAN) port, a Wi-Fi card, a worldwide interoperability for microwave access (WiMax) card, mobile communications hardware, near-field communication (NFC) hardware, satellite communication hardware, and/or any wired or wireless hardware for communicating with other networks and/or devices. In certain aspects, network interface hardware 570 includes hardware configured to operate in accordance with the Bluetooth wireless communication protocol. In certain aspects, network interface hardware 570 may include a Bluetooth send/receive module for sending and/or receiving Bluetooth communications to/from network 580 and/or another vehicle or device.

### Example Device for Uncertainty Estimation

FIG. 6 depicts aspects of an example device 600 configured to perform state prediction and uncertainty estimation. For example, device 600 may be configured to estimate the uncertainty of a DL-based object tracking system.

Device 600 includes a processing system 605. In certain aspects, processing system 605 may be coupled to a transceiver 607 (e.g., a transmitter and/or a receiver) and/or a network interface 697. The transceiver 607 may be configured to transmit and receive signals for the device 600 via an antenna 609, such as the various signals as described herein. The network interface 697 may be configured to obtain and send signals for the device 600 via communications link(s).

The processing system 605 includes one or more processors 610. The one or more processors 610 are coupled to a computer-readable medium/memory 655 via a bus 503. In certain aspects, the computer-readable medium/memory 655 is configured to store instructions (e.g., computer-executable code), including code 660-685, that when executed by the one or more processors 610, enable and cause the one or more processors 610 to perform the method 400 described with respect to FIG. 4, and/or any aspect related to method 400, including any operations described in relation to FIG. 2. Note that reference to a processor of device 600 performing a function may include one or more processors of device 600 performing that function, such as in a distributed fashion.

In the depicted example, the computer-readable medium/memory 655 stores code 631 for processing, code 632 for generating, code 633 for providing, code 634 for predicting, code 635 for calculating, code 636 for deriving, and code 637 for receiving. Processing of the code 631-637 may enable and cause the device 600 to perform the method 400 described with respect to FIG. 4 and/or any aspect related to method 400.

The one or more processors 610 include circuitry configured to implement (e.g., execute) the code (e.g., executable instructions) stored in the computer-readable medium/memory 655, including circuitry 621 for processing, circuitry 622 for generating, circuitry 623 for providing, circuitry 624 for predicting, circuitry 625 for calculating, circuitry 626 for deriving, and circuitry 627 for receiving. Processing with circuitry 621-627 may enable and cause the device 600 to perform the method 400 described with respect to FIG. 4 and/or any aspect related to method 400.

Various components of the device 600 may provide means for performing the method 400 described with respect to FIG. 4 and/or any aspect related to method 400. For example, means for obtaining, processing, generating, initializing, determining, and/or modify of the method 400 described with respect to FIG. 4 and/or any aspect related to method 400 may include one or more processors 610 of the device 600 in FIG. 6.

### EXAMPLE CLAUSES

Implementation examples are described in the following numbered clauses:

Clause 1: A method for uncertainty estimation comprising: processing, with a deep learning network, an input state associated with an object to predict an output state for the object, wherein the output state comprises a plurality of state estimates for a first time period; and generating a state covariance based at least in part on estimated covariance between at least two state estimates of the plurality of state estimates, wherein the state covariance represents an estimated uncertainty associated with the output state.

Clause 2: The method of Clause 1, further comprising: providing as output the output state and the state covariance.

Clause 3: The method of any one of Clauses 1-2, wherein the estimated covariance between at least the two state estimates is not equal to zero.

Clause 4: The method of any one of Clauses 1-3, wherein generating the state covariance comprises generating a full rank state covariance matrix based on a respective estimated covariance between each pair of state estimates of the plurality of state estimates.

Clause 5: The method of any one of Clauses 1-4, wherein generating the state covariance comprises generating a state covariance matrix based on a Kalman filter.

Clause 6: The method of Clause 5, wherein generating the state covariance matrix based on the Kalman filter comprises: predicting the state covariance matrix based on: a state transition matrix, a previous state covariance matrix associated with a second time period prior in time to the first time period, and a process covariance matrix.

Clause 7: The method of Clause 6, further comprising generating the state transition matrix based on at least one of: a constant velocity motion model; a constant acceleration motion model; a Singer model; an Alpha-Beta model; a coordinated turn motion model; or a constant turn rate motion model.

Clause 8: The method of any one of Clauses 6-7, further comprising calculating the state transition matrix based on a least squares means method, the input state, and the output state.

Clause 9: The method of any one of Clauses 6-8, further comprising deriving the process covariance matrix based on an unbiased filter that is based on a normalized estimation error squared method or a normalized innovation squared method.

Clause 10: The method of any one of Clauses 6-9, wherein the previous state covariance matrix comprises an initial state covariance matrix.

Clause 11: The method of any one of Clauses 6-10, further comprising: receiving, via one or more sensors, one or more sensor measurements for the object; and generating an observation matrix based on the one or more sensor measurements, wherein generating the state covariance matrix based on the Kalman filter further comprises: computing a Kalman gain based on: the state covariance matrix; the observation matrix; and a measurement noise covariance matrix; and updating the state covariance matrix based on: the observation matrix; and the Kalman gain.

Clause 12: The method of Clause 11, wherein the measurement noise covariance matrix is based on at least one of noise associated with the one or more sensor measurements or the one or more sensors.

Clause 13: The method of any one of Clauses 11-12, wherein: the one or more sensors comprise a first sensor; and the measurement noise covariance matrix is based on at least one of a range, an angle, a range-rate, or an angular-rate associated with the first sensor.

Clause 14: The method of any one of Clauses 1-13, wherein the plurality of state estimates comprise two or more of: a center of a bounding box associated with the object; a location of the object; an orientation of the object; a heading of the object; a size of the object; a velocity of the object; or an acceleration of the object.

Clause 15: The method of any one of Clauses 1-13, wherein the input state is based on one or more sensor measurements associated with the object for a second time period.

Clause 16: One or more apparatuses, comprising: one or more memories comprising executable instructions; and one or more processors configured to execute the executable instructions and cause the one or more apparatuses to perform a method in accordance with any one of Clauses 1-15.

Clause 17: One or more apparatuses, comprising: one or more memories; and one or more processors, coupled to the one or more memories, configured to cause the one or more apparatuses to perform a method in accordance with any one of Clauses 1-16.

Clause 18: One or more apparatuses, comprising: one or more memories; and one or more processors, coupled to the one or more memories, configured to perform a method in accordance with any one of Clauses 1-16.

Clause 19: One or more apparatuses, comprising means for performing a method in accordance with any one of Clauses 1-16.

Clause 20: One or more non-transitory computer-readable media comprising executable instructions that, when executed by one or more processors of one or more apparatuses, cause the one or more apparatuses to perform a method in accordance with any one of Clauses 1-16.

Clause 21: One or more computer program products embodied on one or more computer-readable storage media comprising code for performing a method in accordance with any one of Clauses 1-16.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus, comprising a processing system that includes one or more processors and one or more memories coupled with the one or more processors, the processing system configured to cause the apparatus to:
process, with a deep learning network, an input state associated with an object to predict an output state for the object, wherein the output state comprises a plurality of state estimates for a first time period; and
generate a state covariance based at least in part on estimated covariance between at least two state estimates of the plurality of state estimates, wherein the state covariance represents an estimated uncertainty associated with the output state.

2. The apparatus of claim 1, wherein the processing system is configured to cause the apparatus to:
provide as output the output state and the state covariance.

3. The apparatus of claim 1, wherein the estimated covariance between at least the two state estimates is not equal to zero.

4. The apparatus of claim 1, wherein to cause the apparatus to generate the state covariance, the processing system is configured to cause the apparatus to generate a full rank state covariance matrix based on a respective estimated covariance between each pair of state estimates of the plurality of state estimates.

5. The apparatus of claim 1, wherein to cause the apparatus to generate the state covariance, the processing system is configured to cause the apparatus to generate a state covariance matrix based on a Kalman filter.

6. The apparatus of claim 5, wherein to cause the apparatus to generate the state covariance matrix based on the Kalman filter, the processing system is configured to cause the apparatus to:
predict the state covariance matrix based on:
a state transition matrix,
a previous state covariance matrix associated with a second time period prior in time to the first time period, and
a process covariance matrix.

7. The apparatus of claim 6, wherein the processing system is configured to cause the apparatus to generate the state transition matrix based on at least one of:
a constant velocity motion model;
a constant acceleration motion model;
a Singer model;
an Alpha-Beta model;
a coordinated turn motion model; or
a constant turn rate motion model.

8. The apparatus of claim 6, wherein the processing system is configured to cause the apparatus to calculate the state transition matrix based on a least squares means method, the input state, and the output state.

9. The apparatus of claim 6, wherein the processing system is configured to cause the apparatus to derive the process covariance matrix based on an unbiased filter that is based on a normalized estimation error squared method or a normalized innovation squared method.

10. The apparatus of claim 6, wherein the previous state covariance matrix comprises an initial state covariance matrix.

11. The apparatus of claim 6, wherein the processing system is configured to cause the apparatus to:
receive, via one or more sensors, one or more sensor measurements for the object; and
generate an observation matrix based on the one or more sensor measurements,
wherein to cause the apparatus to generate the state covariance based on the Kalman filter, the processing system is configured to cause the apparatus to:
compute a Kalman gain based on:
the state covariance matrix;
the observation matrix; and
a measurement noise covariance matrix; and
update the state covariance matrix based on:
the observation matrix; and
the Kalman gain.

12. The apparatus of claim 11, wherein the measurement noise covariance matrix is based on at least one of noise associated with the one or more sensor measurements or the one or more sensors.

13. The apparatus of claim 11, wherein:
the one or more sensors comprise a first sensor; and
the measurement noise covariance matrix is based on at least one of a range, an angle, a range-rate, or an angular-rate associated with the first sensor.

14. The apparatus of claim 1, wherein the plurality of state estimates comprise two or more of:
a center of a bounding box associated with the object;
a location of the object;
an orientation of the object;
a heading of the object;
a size of the object;
a velocity of the object; or
an acceleration of the object.

15. The apparatus of claim 1, wherein the input state is based on one or more sensor measurements associated with the object for a second time period.

16. A method for uncertainty estimation comprising:
processing, with a deep learning network, an input state associated with an object to predict an output state for the object, wherein the output state comprises a plurality of state estimates for a first time period; and
generating a state covariance based at least in part on estimated covariance between at least two state estimates of the plurality of state estimates, wherein the state covariance represents an estimated uncertainty associated with the output state.

17. The method of claim 16, further comprising:
providing as output the output state and the state covariance.

18. The method of claim 16, wherein the estimated covariance between at least the two state estimates is not equal to zero.

19. The method of claim 16, wherein generating the state covariance comprises generating a full rank state covariance matrix based on a respective estimated covariance between each pair of state estimates of the plurality of state estimates.

20. The method of claim 16, wherein generating the state covariance comprises generating a state covariance matrix based on a Kalman filter.
